(19) United States
(12) Patent Application Publication
(10) Pub. No.: US 2007/0141989 A1
(43) Pub. Date: Jun. 21, 2007

(54) Proximity facilitate device pairing

(75) Inventor: Edward Flinchem, Seattle, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 11/642,393

(22) Filed: Dec. 20, 2006

Related U.S. Application Data
(60) Provisional application No. 60/752,420, filed on Dec. 21, 2005.

(51) Int. Cl. H04B 7/00

(52) U.S. Cl. 455/41.2

(57) ABSTRACT

A portable communication device includes logic to detect another device in wireless proximity, and to determine if a phone number for contacting the other device is stored by the portable communication device. If a phone number for contacting the other device is stored by the portable communication device, the portable communication device automatically initiates pairing with the other device.

### PRIORITY CLAIM

The present application claims priority as a utility patent application corresponding to subject matter of U.S. provisional patent application 60/752,420, titled PROXIMITY FACILITATED DEVICE PAIRING, and filed on Dec. 21, 2005.

### BACKGROUND

Bluetooth technology is rapidly becoming a standard on mobile phones. Bluetooth technology enables users to transfer data between phones, an important benefit. Bluetooth technology incorporates a security feature, known as device “pairing,” to protect users from being spammed. “Pairing,” means that two devices are known to each other and are therefore better trusted and distinct from unpaired devices for the purposes of communication therebetween.

Pairing devices is complicated when a large number of other Bluetooth devices are present within certain range 30-100 feet). Users must wait for one Bluetooth client to identify all devices within range (a slow process, subject to failure by timeout) and present a list from which to choose the correct target of the pairing. Often, many devices still have only a default name from the factory, further confusing the process.

Bluetooth technology is moderately long range, up to 100's of feet. Conventional pairing processes forces one user to select the name of the device to pair with from a list of all devices within range, which in a crowd can be quite long. Further, all phones shipped from the factory have default “friendly” names assigned. Thus it may be difficult for the users to tell one phone from another if multiple phones within a certain range have the same default name (a common occurrence).

Currently, the process of personalizing the “friendly” Bluetooth device name for one's phone is an additional (non-intuitive) task to learn and an unnecessary burden on the user. Furthermore, the personal naming step has to happen before attempting to pair to avoid the default name problem above.

In a conventional Bluetooth pairing process phones continuously broadcast their unique serial numbers (long strings of meaningless digits) and their “friendly” names (human readable, frequently non-unique, e.g., “Nokia 6600”). Phone A begins the pairing process. Phone A listens for all Bluetooth devices within range and presents to the user a list of the “friendly names” and/or a list of the serial numbers. The user chooses one item (phone B) from the list as the one with which to attempt to pair. Phone A sends a Bluetooth signal to phone B requesting to pair. Phone B asks the user to accept or reject pairing with phone A.

Other short range wireless connectivity solutions involve similar types of pairing process as does Bluetooth.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

A portable communication device may detect another device in wireless proximity, determine if a phone number for contacting the other device is stored by the portable communication device, and if a phone number for contacting the other device is stored by the portable communication device, automatically initiate pairing with the other device.

The portable communication device may determine if the phone number of the other device is in one or more collections of one or more of called numbers, speed dials, received calls, address books, or contacts of the portable communication device.

The portable communication device may present as a selectable candidate for pairing an identification of the other device and/or a user thereof on a user interface of the portable communication device. The device may present a name of the user of the other device, and/or a call sign of the user of the other device.

The portable communication device may signal the other device with one or more of an SMS message, sonic signal, contact electrical impulse, or optical signal providing an invitation for the devices to pair. The sonic signal, contact electrical impulse, or optical signal may provide an identification of the portable communication device and/or a user thereof, such as a phone number of the device, or name or call sign of the user thereof. The device may signal the other device with a prominent graphic display that the other device may detect and identify using a camera.

A portable communication device may receive an SMS message from another device, where the SMS message includes an invitation to effect pairing between the devices. The device may extract from the SMS message a phone number of the other device, and if the phone number of the other device is in one or more collections of one or more of called numbers, speed dials, received calls, address books, or contacts, the device may accept pairing with the other device.

The device may highlight the other device on a displayed list of available devices for pairing.

Other system/method/apparatus aspects are described in the text (e.g., detailed description and claims) and drawings forming the present application.

### BRIEF DESCRIPTION OF THE DRAWINGS

FIG. 1 is a block diagram of an embodiment of a mobile phone.

FIGS. 2-6 are flow charts of various embodiments of device pairing processes.

### DESCRIPTION

The present invention reduces or eliminates the need for the user to pick a meaningful name for their phone and finds the physically closest device. Users typically know their own phone number and the numbers of their friends phones and typically have those numbers stored with the names of their friends in the phone book of their phone. The present invention takes advantage of this stored phone book information in order to aid in a pairing evolution.

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

Those skilled in the art will appreciate that logic may be distributed throughout a device, and/or may be comprised of combinations of instructions in memory, processing capability, circuits, and so on. Therefore, in the interest of clarity and correctness logic may not always be illustrated in drawings of devices and systems, although it is present therein.

User devices A and B, such as cell phones, are in proximity and seek to pair their devices for Bluetooth communication (or some other wireless networking technology). In accordance with the present invention, user device A sends an SMS message to user device B which triggers B's Bluetooth client to prompt user device B to accept the pairing. If user devices A and B are known to each other, they probably already have each other's phone numbers saved in their phones.

In one embodiment, one device gives off a unique sonic signature, which the other detects with its microphone. Sound has a much shorter radius of propagation than Bluetooth, thus eliminating false targets. The sonic signature could be outside the range of human hearing.

In one embodiment, one device displays a bold graphic on its screen. The 2nd device isolates the desired target by means of its camera, an image recognition algorithm and an image that is stored that is associated with a previously know device. This method works at very close range and offers 100% discrimination of false targets.

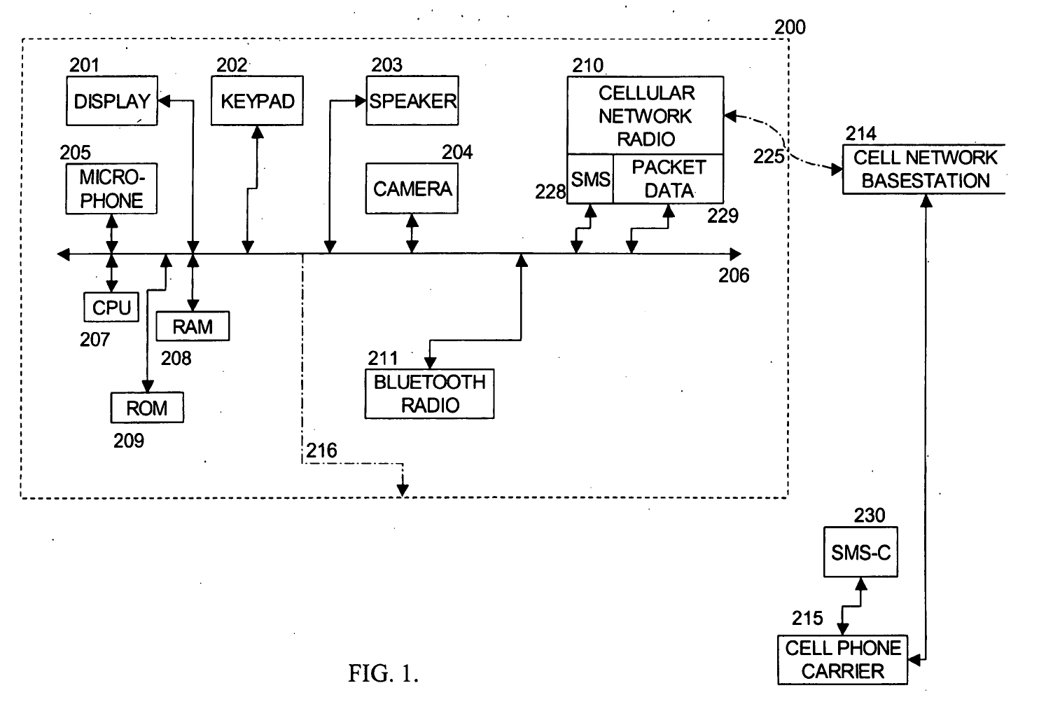

FIG. 1 illustrates a mobile phone 200. Messages are presented on the screen 201. The screen 201 is also used in the user selection of other device with which to pair.

In one embodiment, a camera 204 captures still images or video. A microphone 205 captures sound. Speaker(s) 203 generate sound. A data bus 206 communicatively couples the various elements within the phone. The phone 200 may comprise a processor 207 and random access memory 208 and persistent memory 209 (which could be re-writeable FLASH memory) in order to execute logic in the form of software an/or firmware.

A radio 210 may be provided to communicate via a medium range (up to many kilometers) microwave link 225 with cellular wireless voice and data network base stations 214 through their associated mobile phone carrier 215 and onward to other mobile phones.

The radio 210 may be operative to send and receive both Short Message Service (SMS) messages 228 through the phone network(s) 215 217 to other phones identified by their phone numbers and send a variety of packet data 229 protocols (UDP, TCP, SMTP, HTTP, etc) through the data network 218.

The phone 200 may comprise at least one of a variety of short range wireless communication interfaces, such as Bluetooth 211. The short range wireless communication interface 211 may provide communication directly to other similarly enabled mobile phones.

The cell phone carrier 215 may comprise a short message service center 230 (SMS-C) enabling transmission of messages between phones routed by their phone number.

In one embodiment, a high impedance connection 216 is coupled to an electrically conductive lead on the phone's 200 outer shell.

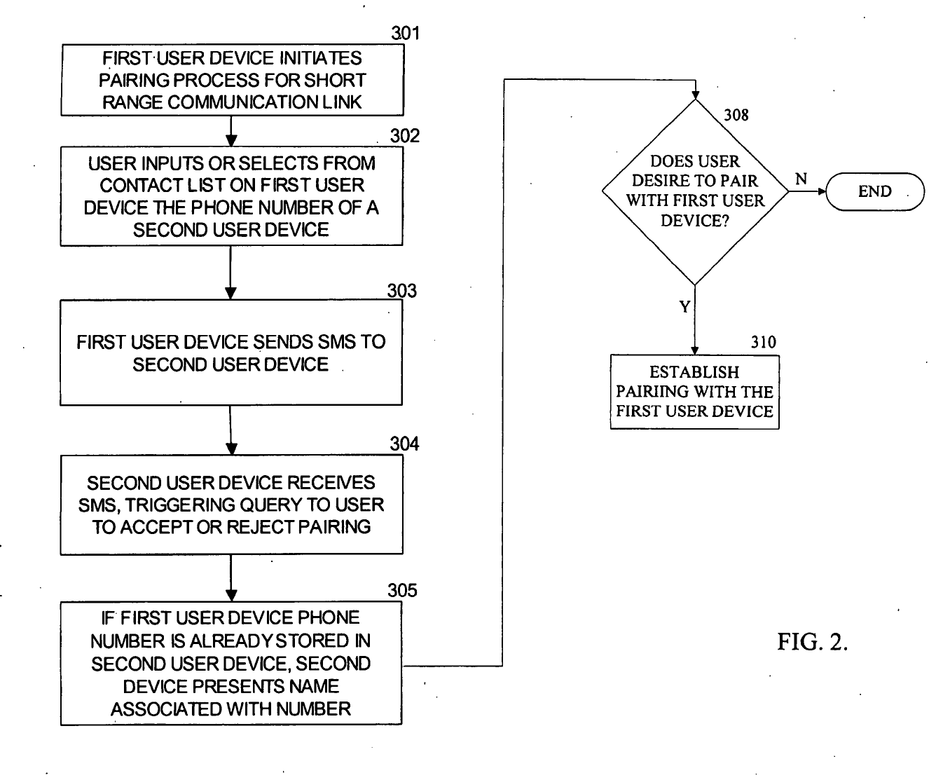

As shown in FIG. 2, at block 301, a first user device initiates a pairing process with another proximate (within short range wireless communication range) device. Pairing is a trusted communication link between two or more devices. At block 302, the user of the first device inputs or selects from a contact list the phone number of a second user device. At block 303, the first user device sends an SMS to the selected second user device. At block 304, the second user device receives the SMS and extracts the sender's phone number therefrom, triggering a query to the user of the second device to accept or reject pairing. The second user device may then determine if a phone number or other identification (e.g. name, call sign) of the first user device, and/or a user thereof, is stored somewhere in a collection of dialed calls, received calls, in an address book, contact list, and so on of the second device. At block 305, if the first user device phone number is already stored in the second user device, the second device presents a name or call sign associated with the phone number. Alternatively, the second user device may automatically accept pairing with the first device when the phone number or other indicia of the first device and/or user thereof is located by the second device.

Other information that identifies the first user device to the second user may be presented on the second user device, such as a photograph. At decision block 308, the user of the second user device determines if they want to effect the pairing with the first user device. If the second user does not want to pair with the first user device, a de-selection or other action is performed by the second user and or second user device in order to reject pairing with the first device. If the second user does want to pair with the first user device, at block 310, a selection or similar action is performed by the second user and the pairing is established. The steps performed at blocks 308 and 310 are repeated at the end of the following processes. Again, the pairing may occur automatically, or via an explicit user selection to do so.

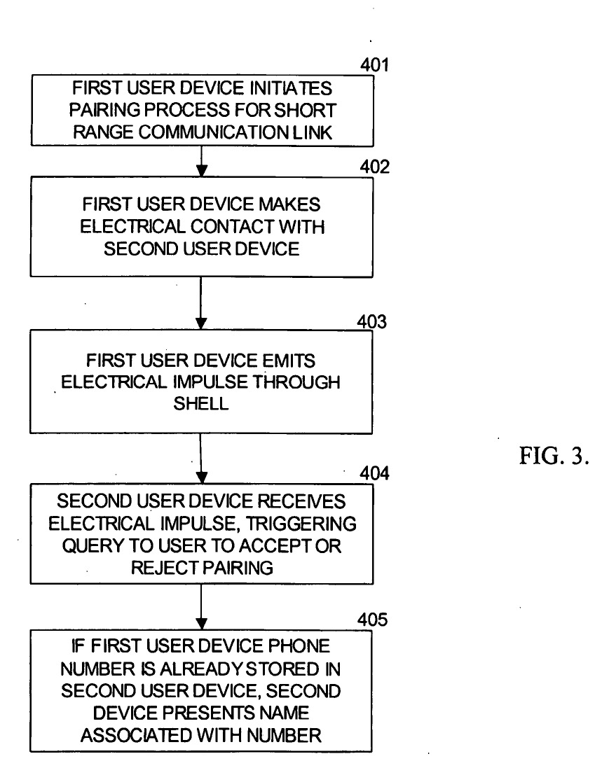

As shown in FIG. 3, at block 401, the first user device initiates a pairing process with a second device. At block 402, the first user device makes electrical contact with the second user device via physical contact at the external leads on the shell or via a wired connection. At block 403, the first user device emits an electrical impulse through an electrically conductive lead on the shell. The electrical impulse may include information such as an identification of the first user device and/or a user thereof. At block 404, the second user device receives the electrical impulse. The received electrical impulse triggers a query for the user of the second device to accept or reject pairing. At block 405, if the first user device phone number (which may have been passed via the contact electrical impulse) is already stored by second user device, the second device presents a name associated with the stored phone number.

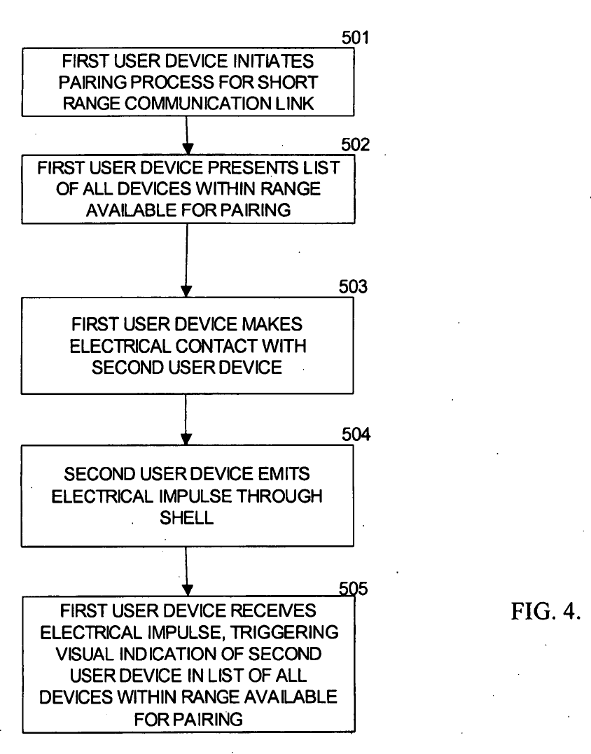

As shown in FIG. 4, at block 501, the first user device initiates a pairing process with a second device. At block 502, the first user device presents a list of all devices within range available for pairing. At block 503, the first user device makes electrical contact with a second user device via physical contact at the external leads on the shell or via a wired connection. At block 504, the second user device emits electrical impulse through to an electrically conductive lead on the shell. At block 505, the first user device receives the electrical impulse, triggering a visual indication (e.g. highlighting) of the second user device and/or a name associated therewith in list of all devices within range available for pairing. In other words, the electrical contact may serve to disambiguate with which proximate device the second device should pair.

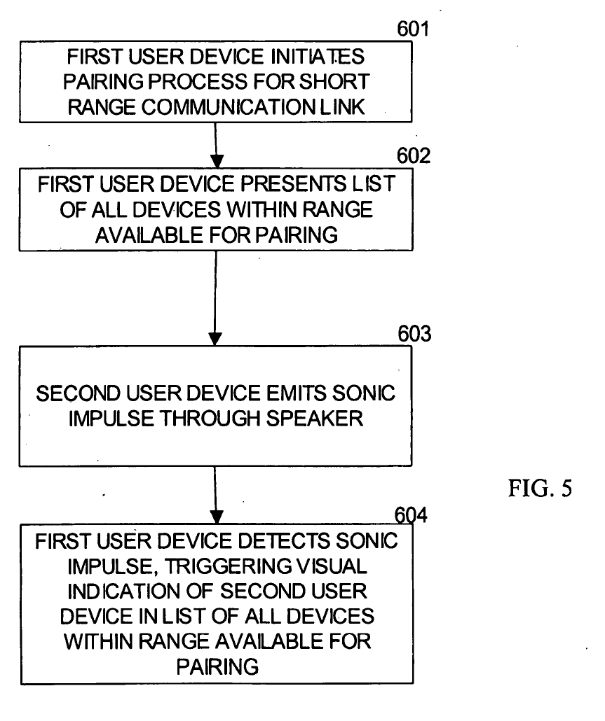

As shown in FIG. 5, at block 601, the first user device initiates pairing with a second device. At block 602, the first user device presents a list of devices within range available for pairing. At block 603, a second user device emits one or more sonic signals (e.g. impulses) via speaker(s). At block 604, the first user device detects the sonic signals, triggering one or more visual indications of the second user device (e.g. highlighting the name or phone number) in the list of devices within range available for pairing.

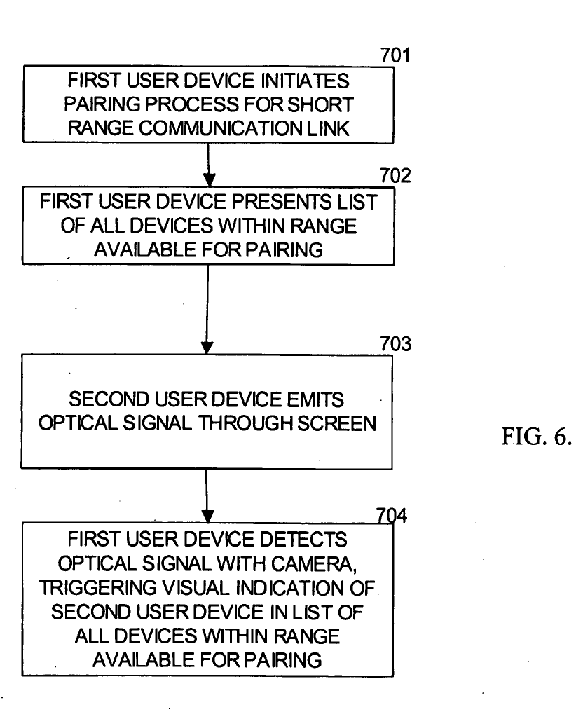

As shown in FIG. 6, at block 701, the first user device initiates pairing with a second device. At block 702, the first user device presents a list of devices within range available for pairing. At block 703, the second user device emits one or more optical signals via a screen (e.g. display) and/or one or more optical communication ports. At block 704, the first user device detects the optical signal(s) with a camera, triggering one or more visual indications of second user device in the list of devices within range available for pairing.

In each embodiment, rather than involving the user to select pairing, pairing may occur automatically between the devices once the receiving device identifies a phone number or other indicia of the initiating device among a collection of dialed calls, received calls, an address book, a contact list, and so on.

The electrical and sonic impulses, SMS and optical signals may include data for identifying the sender device.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A portable communication device comprising logic to:
detect another device in wireless proximity;
determine if a phone number for contacting the other device is stored by the portable communication device; and
if a phone number for contacting the other device is stored by the portable communication device, automatically initiate pairing with the other device.

2. The portable communication device of claim 1, further comprising logic to:
determine if the phone number of the other device is in one or more collections of one or more of called numbers, speed dials, received calls, address books, or contacts of the portable communication device.

3. A portable communication device comprising logic to:
detect another device in wireless proximity;
determine if a phone number for contacting the other device is stored by the portable communication device; and
if a phone number for contacting the other device is stored by the portable communication device, present as a selectable candidate for pairing an identification of the other device and/or a user thereof on a user interface of the portable communication device.

4. The portable communication device of claim 3, further comprising logic to:
determine if the phone number of the other device is in one or more collections of one or more of called numbers, speed dials, received calls, address books, or contacts of the portable communication device.

5. The portable communication device of claim 3, wherein the logic to present as a selectable candidate for pairing an identification of the other device and/or a user thereof on a user interface of the portable communication device further comprises:
logic to present a name of the user of the other device.

6. The portable communication device of claim 3, wherein the logic to present as a selectable candidate for pairing an identification of the other device and/or a user thereof on a user interface of the portable communication device further comprises:
logic to present a call sign of the user of the other device.

7. A portable communication device comprising logic to:
detect another device in wireless proximity;
determine if a phone number for contacting the other device is stored by the portable communication device; and
if a phone number for contacting the other device is stored by the portable communication device, signal the other device with one or more of an SMS message, sonic signal, contact electrical impulse, or optical signal providing an invitation for the devices to pair.

8. The portable communication device of claim 7, wherein further comprising:
logic to determine if the phone number of the other device is in one or more collections of one or more of called numbers, speed dials, received calls, address books, or contacts of the portable communication device.

9. The portable communication device of claim 7, wherein the logic to signal the other device with one or more of an SMS message, sonic signal, contact electrical impulse, or optical signal providing an invitation for the devices to pair further comprises:
logic to signal the other device with one or more of a sonic signal, contact electrical impulse, or optical signal providing an identification of the portable communication device and-or a user thereof.

10. The portable communication device of claim 9, wherein the logic to signal the other device with one or more of a sonic signal, contact electrical impulse, or optical signal providing an identification of the portable communication device and/or a user thereof further comprises:
logic to signal the other device with a phone number of the portable communication device.

11. The portable communication device of claim 9, wherein the logic to signal the other device with one or more of a sonic signal, contact electrical impulse, or optical signal providing an identification of the portable communication device and/or a user thereof further comprises:
logic to signal the other device with a prominent graphic display.

12. A portable communication device comprising logic to:
receive an SMS message from another device comprising an invitation to effect pairing between the devices;
extract from the SMS message a phone number of the other device; and
if the phone number of the other device is in one or more collections of one or more of called numbers, speed dials, received calls, address books, or contacts, accept pairing with the other device.

13. A portable communication device comprising logic to:
receive at least one of a sonic signal, contact electrical impulse, or optical signal from another device comprising a phone number of the other device and an invitation to effect pairing with the other device; and
if the phone number of the other device is in one or more collections of one or more of called numbers, speed dials, received calls, address books, or contacts, accept pairing with the other device.

14. A portable communication device comprising logic to:
receive at least one of a sonic signal, contact electrical impulse, or optical signal from another device comprising a phone number of the other device and an invitation to effect pairing with the other device; and
highlight the other device on a displayed list of available devices for pairing.
